(19) United States
(12) Patent Application Publication
(10) Pub. No.: US 2025/0014778 A1
(43) Pub. Date: Jan. 9, 2025

(54) Flexible Flat Coaxial Ribbon Cable

(71) Applicant: HARUMOTO TECHNOLOGY (SHEN ZHEN) CO., LTD., Shenzhen (CN)

(72) Inventors: CHING-CHUAN KUNG, Taipei (TW); Xiang-Yu Chen, Yongzhou (CN); YI-JU LU, Taipei (TW); Ning Qin, Laibin (CN)

(21) Appl. No.: 18/764,966

(22) Filed: Jul. 5, 2024

(30) Foreign Application Priority Data
Jul. 7, 2023 (CN) 202310835747.8

(51) Int. Cl. H01B 7/08

(52) U.S. Cl. CPC H01B 7/0861; H01B 7/0838

(57) ABSTRACT

A flexible flat coaxial ribbon cable, equipped with a plurality of coaxial cables arranged side by side to reduce the degree of interference and loss during transmitting RF signals or high-speed signals through the coaxial cables, thereby effectively increasing the transmission distance for RF signals or high-speed signals. Additionally, the coaxial cables used in the flexible flat coaxial ribbon cable of this application omits an outer insulation layer, allowing the thickness of the flexible flat coaxial ribbon cable to be effectively reduced for use in spaces with height constraints.

### CROSS-REFERENCE TO RELATED APPLICATIONS

This application claims the priority of China Patent Application No. 202310835747.8 filed on Jul. 7, 2023, in the State Intellectual Property Office of China, the disclosure of which is incorporated herein by reference.

### BACKGROUND OF THE INVENTION

### Field of the Invention

This application relates to the field of electronic device technology, specifically concerning a flexible flat coaxial ribbon cable that utilizes coaxial cables omitting outer insulation layers for transmitting RF signals or high-speed signals.

### Descriptions of the Related Art

Flexible ribbon cables are thin (approximately 0.20˜0.40 mm thick) and highly flexible cables used to transmit electrical signals in space-constrained electronic devices. For instance, due to the trend towards slim and lightweight designs of smartphones and tablets, there is a need for flexible ribbon cables that can bend to save space, connecting electrical components such as antennas, displays, touch panels, buttons, and batteries to transmit electrical signals.

It should be noted that common types of flexible ribbon cables include flexible flat cables (FFC) and flexible printed circuits (FPC). Flexible flat cables are typically composed of layers of adhesive film bonding layers of metal conductor arrays, and the metal conductor array consists of a plurality of thin and long metal conductors arranged in a row. The flexible printed circuits usually embed circuit designs on a flexible film substrate.

Therefore, the structural designs of existing flexible ribbon cables and flexible printed circuits fail to effectively prevent leakage during the transmission of RF signals or high-speed signals. Consequently, existing flexible cables encounter challenges in electronic devices during transmitting RF signals or high-speed signals, as they are prone to leakage losses or serve as sources of noise interference in signal transmission. This tendency leads to signal loss and distortion within flexible cables, severely limiting the permissible transmission distance for RF signals or high-speed signals. As a result, the performance of flexible cables in transmitting RF signals or high-speed signals does not meet expectations.

Therefore, reducing interference and losses during the transmission of RF signals or high-speed signals through flexible cables, thereby effectively increasing their transmission distance for RF signals or high-speed signals, is an urgent issue for professionals in the field of electronic device technology.

### SUMMARY OF THE INVENTION

In view of the drawbacks of the prior art mentioned above, the present application provides a flexible flat coaxial ribbon cable, and the flexible flat coaxial ribbon cable including: a ribbon cable assembly, comprising a first coaxial cable and a second coaxial cable, wherein the first coaxial cable has a first coaxial cable inner conductor layer, a first coaxial cable inner insulation layer, and a first coaxial cable outer conductor layer, and the first coaxial cable inner insulation layer encases the first coaxial cable inner conductor layer, and the first coaxial cable outer conductor layer encases the first coaxial cable inner insulation layer; the second coaxial cable has a second coaxial cable inner conductor layer, a second coaxial cable inner insulation layer, and a second coaxial cable outer conductor layer, and the second coaxial cable inner insulation layer encases the second coaxial cable inner conductor layer, and the second coaxial cable outer conductor layer encases the second coaxial cable inner insulation layer; and a ribbon cable sheath, including an upper gel film and a lower gel film, and both sides of the upper gel film and the lower gel film can be joined, and allow the ribbon cable assembly and the ribbon cable sheath to form a ribbon cable component, in the ribbon cable component, the upper gel film is positioned above the first coaxial cable outer conductor layer and the second coaxial cable outer conductor layer, and the lower gel film is positioned below the first coaxial cable outer conductor layer and the second coaxial cable outer conductor layer, and the upper gel film and the lower gel film are in contact with the first coaxial cable outer conductor layer and the second coaxial cable outer conductor layer.

Preferably, the flexible flat coaxial ribbon cable said above, the ribbon cable component has a bending extension segment, and the ribbon cable assembly extends and bends at the bending extension segment.

Preferably, the flexible flat coaxial ribbon cable said above, the ribbon cable assembly further comprises at least a non-coaxial cable, in the ribbon cable component, the upper gel film is positioned above the non-coaxial cable, and the lower gel film is positioned below the non-coaxial cable, wherein the cross-sectional profile shape or size of the first coaxial cable, the second coaxial cable, and the non-coaxial cable can be substantially the same or different; the non-coaxial cable can be a metal cable, an electronic cable, or a plastic cable.

Preferably, the flexible flat coaxial ribbon cable said above, the ribbon cable component further includes a coaxial cable layout area and a non-coaxial cable layout area, and the first coaxial cable and the second coaxial cable are respectively arranged in the coaxial cable layout area, and the non-coaxial cable is arranged in the non-coaxial cable layout area, and the coaxial cable layout area and the non-coaxial cable layout area can overlap or be separate, wherein when the coaxial cable layout area overlaps the non-coaxial cable layout area, the non-coaxial cable is positioned between the first coaxial cable and the second coaxial cable, when the coaxial cable layout area is separated from the non-coaxial cable layout area, the non-coaxial cable is positioned away from the coaxial cable layout area.

Preferably, the flexible flat coaxial ribbon cable said above, the ribbon cable component further includes a cable separating space separating the first coaxial cable, the second coaxial cable, and the non-coaxial cable, and the separation distance between any two adjacent ones of the first coaxial cable, the second coaxial cable, and the non-coaxial cable can be the same or different.

Preferably, the flexible flat coaxial ribbon cable said above, in the ribbon cable component, any two adjacent ones of the first coaxial cable, the second coaxial cable, and the non-coaxial cable are in close contact.

Preferably, the flexible flat coaxial ribbon cable said above, the upper gel film has an upper gel adhesive layer, and the lower gel film has a lower gel adhesive layer, the upper gel adhesive layer adheres to the first coaxial cable outer conductor layer and the second coaxial cable outer conductor layer above the ribbon cable assembly, and the lower gel adhesive layer adheres to the first coaxial cable outer conductor layer and the second coaxial cable outer conductor layer below the ribbon cable assembly.

Preferably, the flexible flat coaxial ribbon cable said above, the upper gel film has an upper conductive layer, and the lower gel film has a lower conductive layer, and the upper conductive layer electrically connects the first coaxial cable outer conductor layer and the second coaxial cable outer conductor layer, and the lower conductive layer electrically connects the first coaxial cable outer conductor layer and the second coaxial cable outer conductor layer.

Preferably, the flexible flat coaxial ribbon cable said above, the upper gel film and the lower gel film are adhesive films, thermoadhesive films, or thermocompression films; and the first coaxial cable outer conductor layer and the second coaxial cable outer conductor layer have single-layer or multi-layer conductor structures made of at least one of braided metal, wrapped metal, or wound metal.

Preferably, the flexible flat coaxial ribbon cable said above further including a plurality of auxiliary cables, and the auxiliary cables are respectively located on both sides of the ribbon cable assembly to assist in the joining of both sides of the upper gel film and the lower gel film.

Compared to prior art, the present application provides a flexible flat coaxial ribbon cable, equipped with a plurality of coaxial cables arranged side by side to reduce the degree of interference and loss during transmitting RF signals or high-speed signals through the coaxial cables, thereby effectively increasing the transmission distance for RF signals or high-speed signals. Additionally, the coaxial cables used in the flexible flat coaxial ribbon cable of this application omits an outer insulation layer, allowing the thickness of the flexible flat coaxial ribbon cable to be effectively reduced for use in spaces with height constraints.

### BRIEF DESCRIPTION OF THE DRAWINGS

The above and other aspects, has and other advantages of the present invention will be more clearly understood from the following detailed description taken in conjunction with the accompanying drawings, in which:

FIG. 1 is a three-dimensional schematic diagram showing that the flexible flat coaxial ribbon cable in the present application arranges side by side with the plurality of coaxial cables omitting an outer insulation layer.

FIG. 2 is a cross-sectional schematic diagram showing that the plurality of coaxial cables of the flexible flat coaxial ribbon cable in the present application are arranged in close contact with each other.

FIG. 3 is a three-dimensional schematic diagram showing that the plurality of coaxial cables of the flexible flat coaxial ribbon cable in the present application are arranged with separation between each adjacent pair.

FIG. 4 is a three-dimensional schematic diagram showing that the flexible flat coaxial ribbon cable in the present application arranges side by side with the non-coaxial cables and the coaxial cables omitting an outer insulation layer.

FIG. 5 is a cross-sectional schematic diagram showing that the non-coaxial cables and the plurality of coaxial cables of the flexible flat coaxial ribbon cable in the present application are arranged in close contact with each other.

FIG. 6 is a cross-sectional schematic diagram showing that the non-coaxial cables and the plurality of coaxial cables of the flexible flat coaxial ribbon cable in the present application are arranged with separation between each adjacent pair.

FIG. 7 is a three-dimensional schematic diagram showing that the non-coaxial cables and the plurality of coaxial cables of the flexible flat coaxial ribbon cable in the present application are laid out in separate sections.

FIG. 8 is a cross-sectional schematic diagram showing that the non-coaxial cables and the plurality of coaxial cables of the flexible flat coaxial ribbon cable in the present application are laid out in separate sections.

FIG. 9 is a cross-sectional schematic diagram showing that the non-coaxial cables and the plurality of coaxial cables of the flexible flat coaxial ribbon cable in the present application have the same diameter.

FIG. 10 is a cross-sectional schematic diagram showing that the non-coaxial cables and the plurality of coaxial cables of the flexible flat coaxial ribbon cable in the present application have the different diameter.

FIG. 11 is a cross-sectional schematic diagram showing that the ribbon cable sheath of the flexible flat coaxial ribbon cable in the present application has a gel adhesive layer.

FIG. 12 is a cross-sectional schematic diagram showing that the ribbon cable sheath of the flexible flat coaxial ribbon cable in the present application has a conductive layer.

FIG. 13 is a cross-sectional schematic diagram showing that the flexible flat coaxial ribbon cable in the present application has a plurality of auxiliary cables.

FIG. 14 is a top view diagram showing that the ribbon cable component of the flexible flat coaxial ribbon cable in the present application has a bending extension segment.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

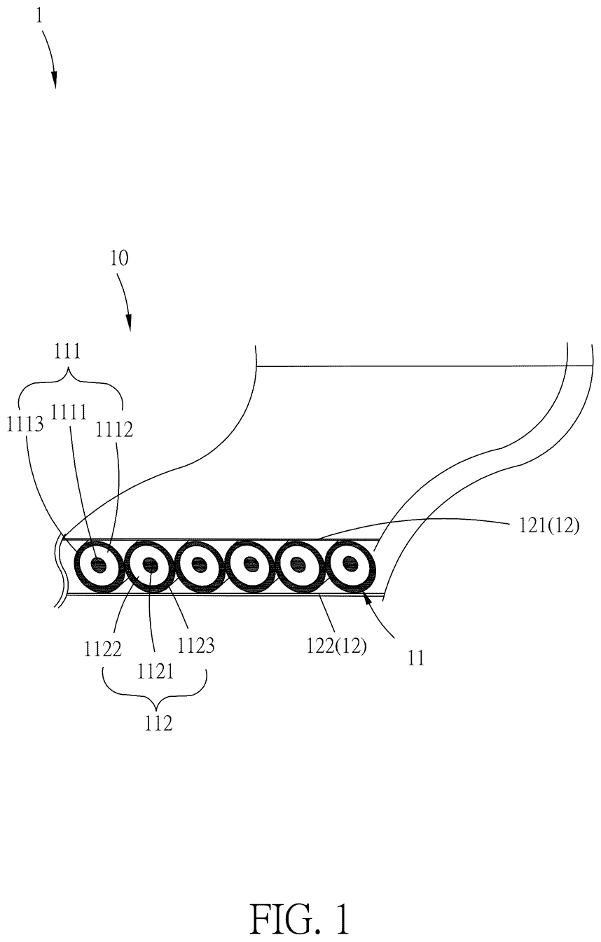

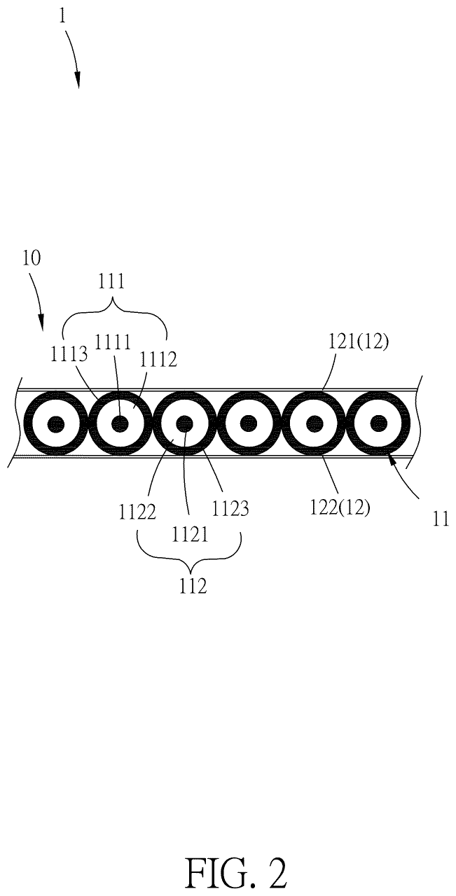

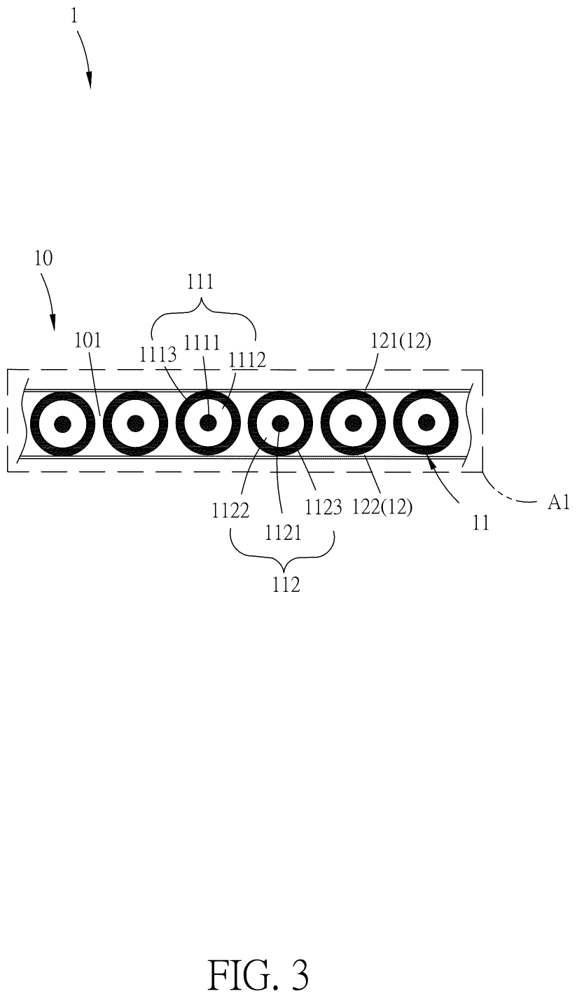

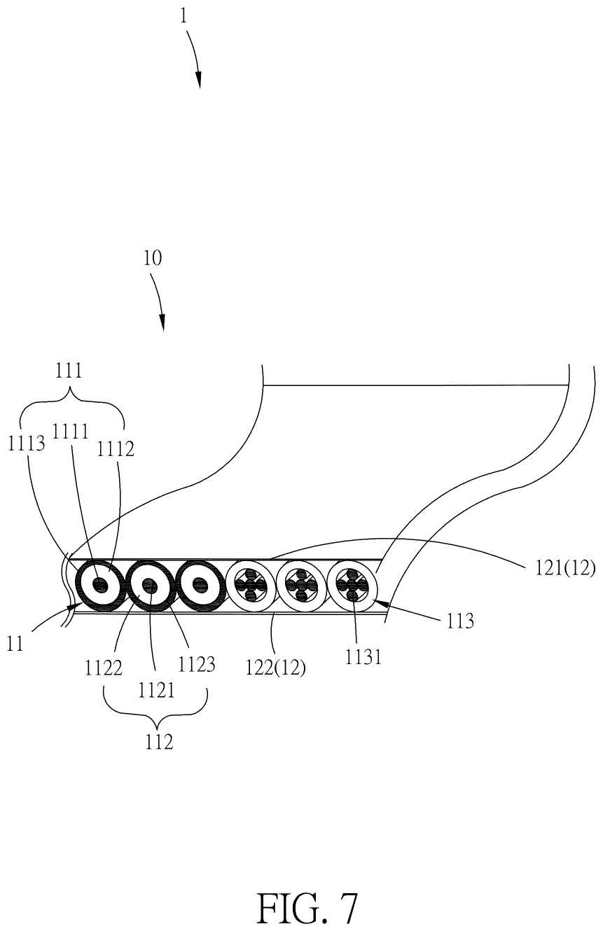

For a detailed description of the embodiments of the flexible flat coaxial ribbon cable disclosed in the present application, please refer to FIGS. 1 to 14.

In the above embodiment, a flexible flat coaxial ribbon cable 1 is provided, and the flexible flat coaxial ribbon cable 1 includes: a ribbon cable assembly 11 and a ribbon cable sheath 12. The ribbon cable assembly 11 comprises a first coaxial cable 111 and a second coaxial cable 112. The ribbon cable sheath 12 is provided to encase and position the ribbon cable assembly 11. As shown in embodiments from FIG. 1 to FIG. 13, the ribbon cable sheath 12 comprises an upper gel film 121 and a lower gel film 122. It should be noted that the upper gel film 121 and the lower gel film 122 can optionally be gel adhesive films, thermoadhesive films, thermocompression films, but it is not limited to this, other materials suitable for encapsulating and positioning the ribbon cable assembly 11 can be the upper gel film 121 and the lower gel film 122.

As shown in the embodiments from FIG. 1 to FIG. 13, the first coaxial cable 111 omits an outer insulation layer to become a three-layer cable structure, thereby reducing the diameter of the first coaxial cable 111 and consequently reducing the thickness of the flexible flat coaxial ribbon cable 1. In the above embodiment, the three-layer cable structure refers to the first coaxial cable 111 having a first coaxial cable inner conductor layer 1111, a first coaxial cable inner insulation layer 1112, and a first coaxial cable outer conductor layer 1113. The first coaxial cable inner conductor layer 1111 is provided for transmitting RF signals or high-speed signals. The first coaxial cable inner insulation layer 1112 encases and isolates the first coaxial cable inner conductor layer 1111 to provide impedance matching for the transmission of RF signals or high-speed signals of the first coaxial cable inner conductor layer 1111. The first coaxial cable outer conductor layer 1113 encases the first coaxial cable inner insulation layer 1112, serving as a metal shielding layer to provide shielding and prevent RF signal or high-speed signal leakage, loss during transmission by the first coaxial cable inner conductor layer 1111, or formation of noise interference sources of signal transmission, allowing the performance of the flexible flat coaxial ribbon cable 1 in transmitting RF signals or high-speed signals, including transmission distance, to meet expectations. Optionally, the first coaxial cable outer conductor layer 1113 can have a single-layer or multi-layer conductor structure made of at least one of braided metal, wrapped metal, or wound metal.

Similarly, as shown in the embodiments from FIG. 1 to FIG. 13, the second coaxial cable 112 omits an outer insulation layer to become a three-layer cable structure, thereby reducing the diameter of the first coaxial cable 111 and consequently reducing the thickness of the flexible flat coaxial ribbon cable 1. In the above embodiment, the three-layer cable structure refers to the second coaxial cable 112 having a second coaxial cable inner conductor layer 1121, a second coaxial cable inner insulation layer 1122, and a second coaxial cable outer conductor layer 1123. The second coaxial cable inner conductor layer 1121 is provided for transmitting RF signals or high-speed signals. The second coaxial cable inner insulation layer 1122 encases and isolates the second coaxial cable inner conductor layer 1121 to provide impedance matching for the transmission of RF signals or high-speed signals of the second coaxial cable inner conductor layer 1121. The second coaxial cable outer conductor layer 1123 encases the second coaxial cable inner insulation layer 1122, serving as a metal shielding layer to provide shielding and prevent RF signal or high-speed signal leakage, loss during transmission by the second coaxial cable inner conductor layer 1121, or formation of noise interference sources of signal transmission, allowing the performance of the flexible flat coaxial ribbon cable 1 in transmitting RF signals or high-speed signals, including transmission distance, to meets expectations. Optionally, the second coaxial cable outer conductor layer 1123 can have a single-layer or multi-layer conductor structure made of at least one of braided metal, wrapped metal, or wound metal.

As shown in the embodiments from FIG. 1 to FIG. 13, the upper gel film 121 is positioned above the first coaxial cable outer conductor layer 1113, and the lower gel film 122 is positioned below the second coaxial cable outer conductor layer 1123. The sides of the upper gel film 121 and the lower gel film 122 can be joined, for example, by adhesion, allowing the ribbon cable sheath 12 to become an annular body that can encase and position the ribbon cable assembly 11, allowing the upper gel film 121 and the lower gel film 122 to contact the first coaxial cable outer conductor layer 1113 and the second coaxial cable outer conductor layer 1123. Consequently, the first coaxial cable 111 and the second coaxial cable 112 can be arranged side by side to form a flat and flexible ribbon cable component 10, enabling the flexible flat coaxial ribbon cable 1 to be laid out in space-constrained electronic devices, providing electrical signal transmission.

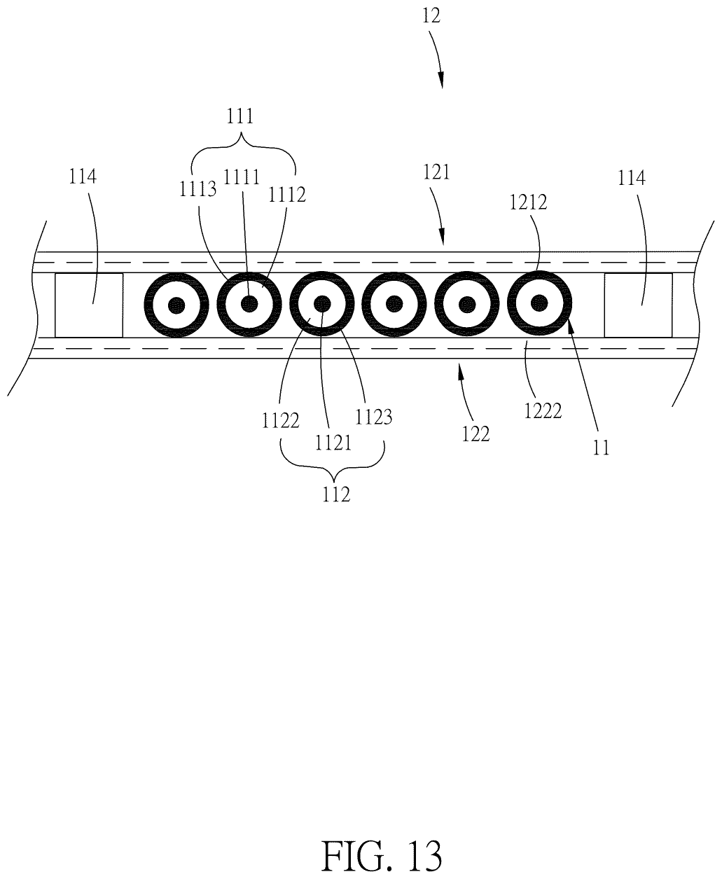

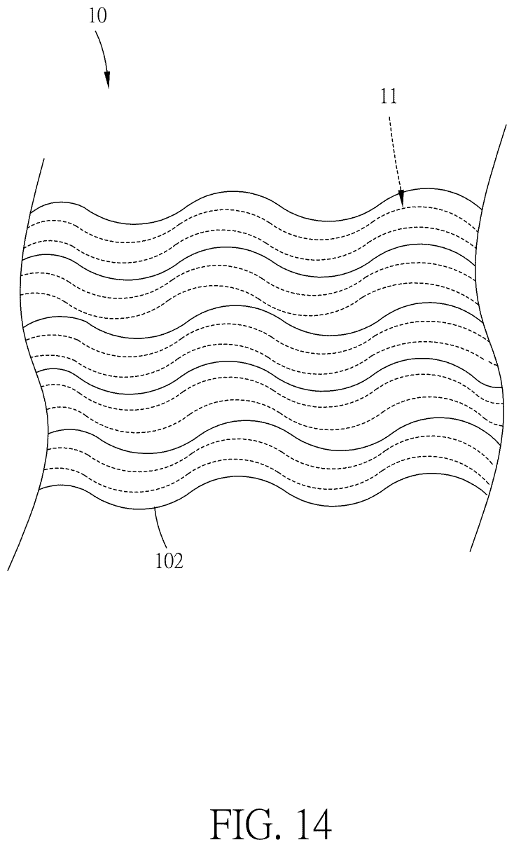

Optionally, as shown in FIG. 14, the ribbon cable component 10 comprises a bending extension segment 102, and the ribbon cable assembly 11 bends and extends through the bending extension segment 102, allowing the flexible flat coaxial ribbon cable 1 to be laid out in space-constrained electronic devices. However, this is not limited to the aforementioned configuration. As shown in FIG. 14, the ribbon cable component 10 can also comprise a straight extension segment, where the ribbon cable assembly 11 extends straight through the straight extension segment, allowing the flexible flat coaxial ribbon cable 1 to be laid out in space-constrained electronic devices. Additionally, as shown in FIG. 13, the flexible flat coaxial ribbon cable 1 also comprises a plurality of auxiliary cables 114, and the auxiliary cables 114 are located on either coaxial cables or non-coaxial cables of both sides of the ribbon cable assembly 11, for instance, the auxiliary cables 114 can be strip-shaped plastic cables, which can join the upper gel film 121 and the lower gel film 122 by melting, thereby assisting in joining the two sides of the upper gel film 121 and the lower gel film 122.

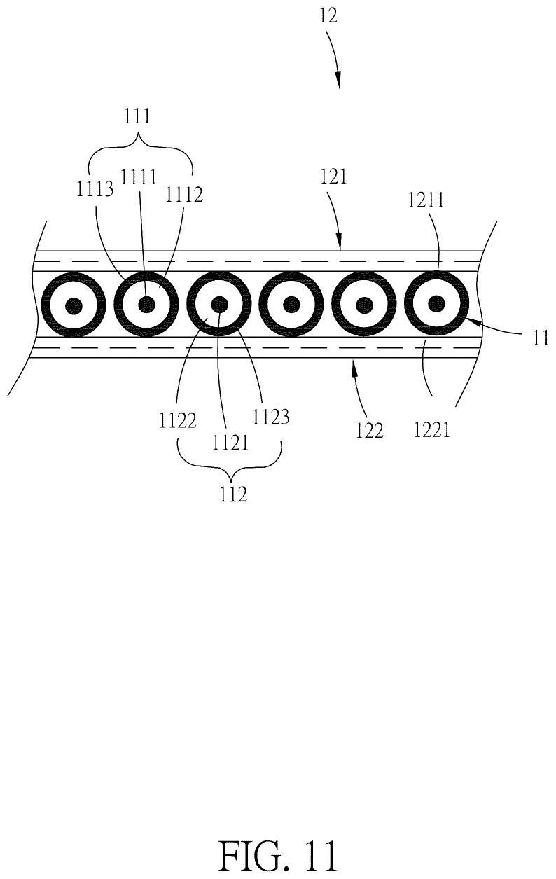

As shown in the embodiment in FIG. 11, the upper gel film 121 comprises an upper gel adhesive layer 1211, and the lower gel film 122 comprises a lower gel adhesive layer 1221. It should be noted that the upper gel adhesive layer 1211 is positioned above the ribbon cable assembly 11, adhering to the first coaxial cable outer conductor layer 1113. The lower gel adhesive layer 1221 is positioned below the ribbon cable assembly 11, adhering to the second coaxial cable outer conductor layer 1123. This arrangement provides adhesive positioning for the first coaxial cable 111 and the second coaxial cable 112, allowing the first coaxial cable 111 and the second coaxial cable 112 to be arranged to form the ribbon cable component 10.

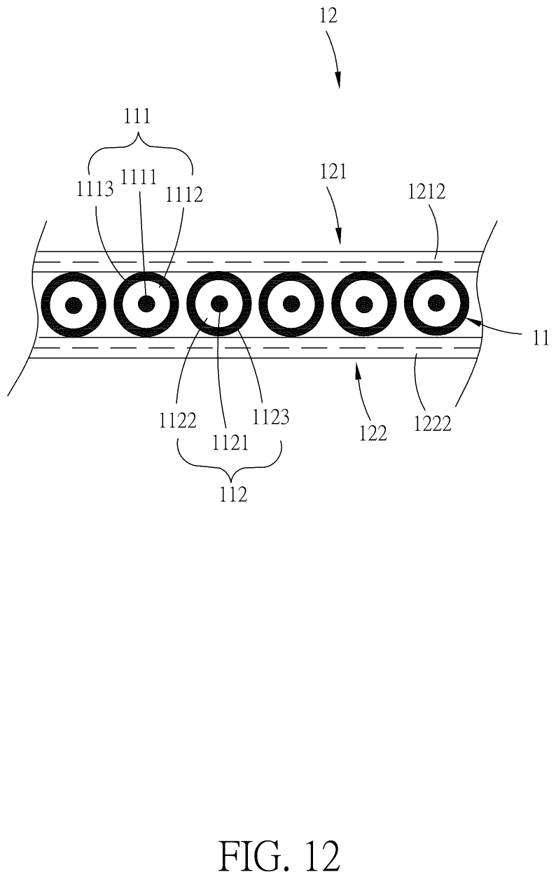

Additionally, as shown in the embodiment in FIG. 12, the upper gel film 121 comprises an upper conductive layer 1212, and the lower gel film 122 comprises a lower conductive layer 1222. It should be noted that the upper conductive layer 1212 is electrically connected to the first coaxial cable outer conductor layer 1113, providing a bridge for the first coaxial cable outer conductor layer 1113. Similarly, the lower conductive layer 1222 is electrically connected to the second coaxial cable outer conductor layer 1123, providing a bridge for the second coaxial cable outer conductor layer 1123. This configuration allows the first coaxial cable outer conductor layer 1113 and the second coaxial cable outer conductor layer 1123 to be electrically connected, thereby providing a shielded environment for the electrical signal transmission of the first coaxial cable inner conductor layer 1111 and the second coaxial cable inner conductor layer 1121, preventing RF signal or high-speed signal leakage and loss transmitted by the first coaxial cable inner conductor layer 1111 and the second coaxial cable inner conductor layer 1121, or the formation of noise interference sources of signal transmission.

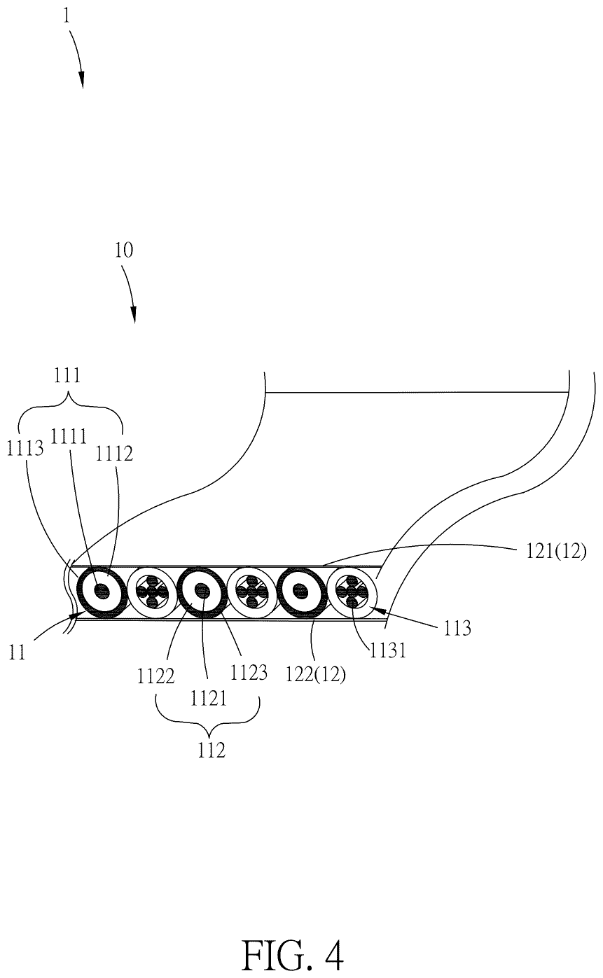

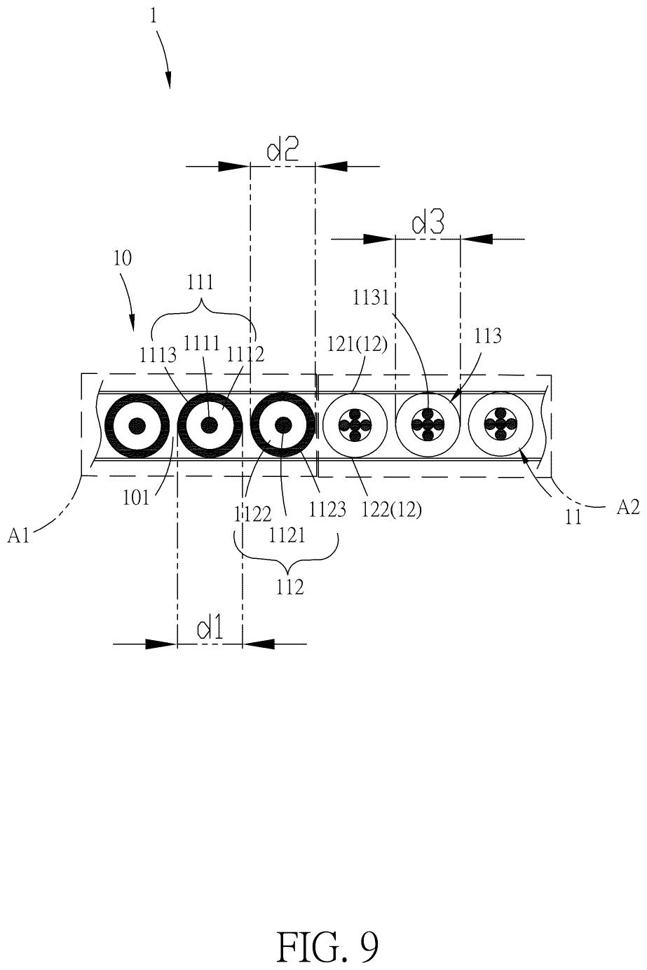

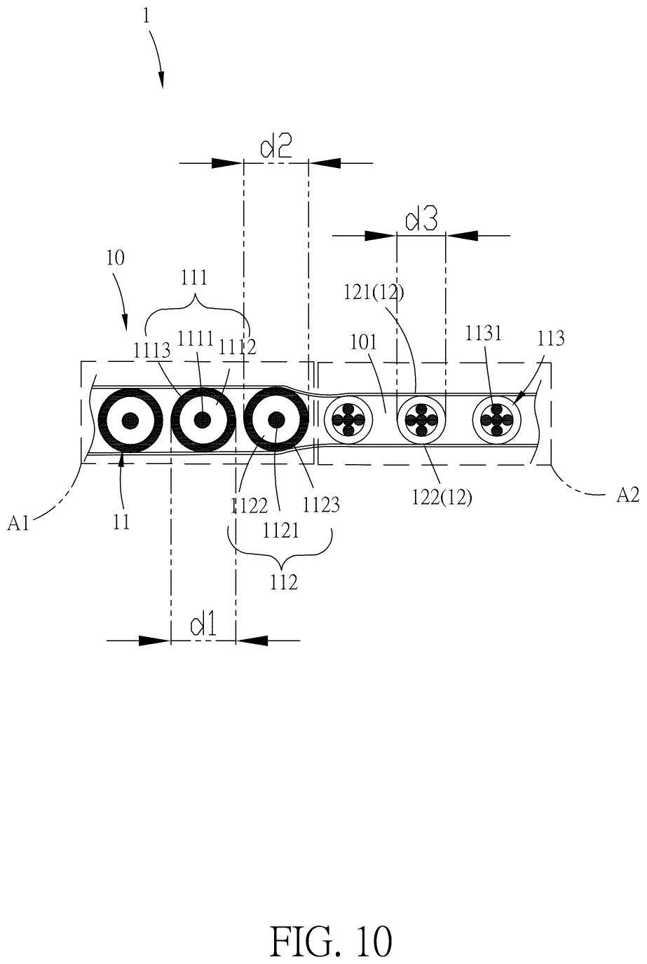

As shown in the embodiments in FIGS. 4 to 10, the ribbon cable assembly 11 may also comprises a plurality of non-coaxial cables 113, which can be strip-shaped metal cables, electronic cables, or plastic cables. Additionally, the number of non-coaxial cables 113 of the ribbon cable assembly 11 is not limited to multiple, and the number of non-coaxial cables 113 of the ribbon cable assembly 11 can be single. Furthermore, the cross-sectional shape or size of the first coaxial cable 111, the second coaxial cable 112, and the non-coaxial cable 113 can be chosen to be substantially the same or different. For example, the diameter d1 of the first coaxial cable 111, the diameter d2 of the second coaxial cable 112, and the diameter d3 of the non-coaxial cable 113 can be substantially the same (see FIG. 9) or different (see FIG. 10). Moreover, the cross-sectional shape of the non-coaxial cable 113 can be non-circular.

As shown in the embodiments in FIGS. 4 to 10, the upper gel film 121, in addition to being positioned above the first coaxial cable outer conductor layer 1113 and the second coaxial cable outer conductor layer 1123, can also be located above the non-coaxial cable 113. Similarly, the lower gel film 122, in addition to being positioned below the first coaxial cable outer conductor layer 1113 and the second coaxial cable outer conductor layer 1123, can also be located below the non-coaxial cable 113. This allows the first coaxial cable 111, the second coaxial cable 112, and the second coaxial cable outer conductor layer 1123 to be arranged to form a flat and flexible ribbon cable component 10, allowing the flexible flat coaxial ribbon cable 1 to be suitable for transmitting both RF signals (or high-speed signals) and non-RF electrical signals in space-constrained electronic devices.

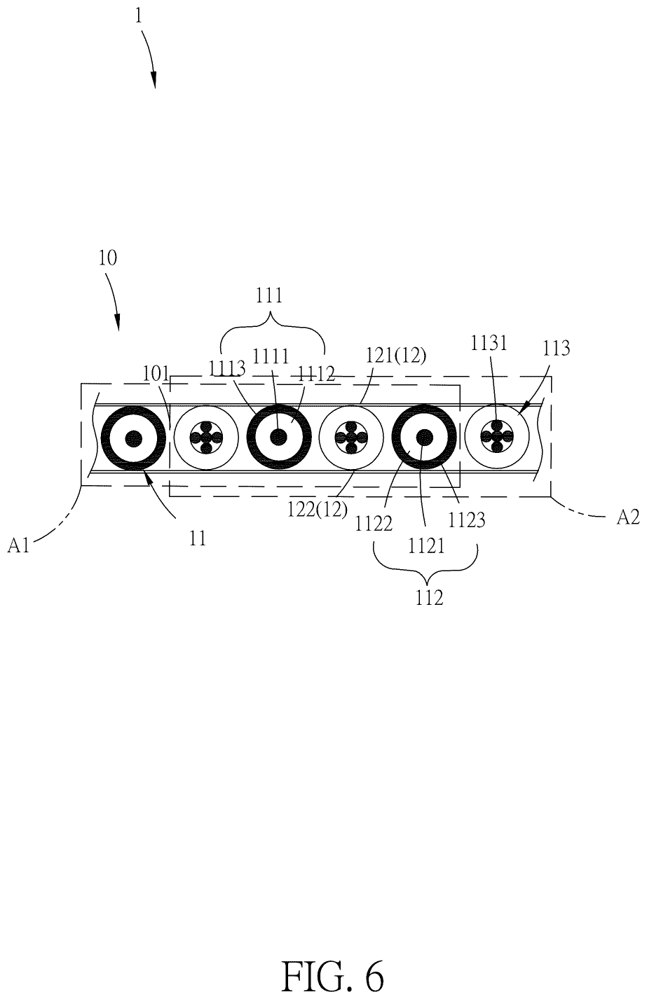

The first coaxial cable 111 and the second coaxial cable 112 are respectively laid out in the coaxial cable layout area A1 in the ribbon cable component 10, while the non-coaxial cable 113 is laid out in the non-coaxial cable layout area A2. In the embodiment shown in FIG. 6, the coaxial cable layout area A1 and the non-coaxial cable layout area A2 can overlap. When the coaxial cable layout area A1 and the non-coaxial cable layout area A2 overlap, the non-coaxial cable 113 is positioned between the first coaxial cable 111 and the second coaxial cable 112 to meet the signal transmission requirements of the electronic device. However, this is not limited to the above; the coaxial cable layout area A1 and the non-coaxial cable layout area A2 can also be separate. When the coaxial cable layout area A1 and the non-coaxial cable layout area A2 are separated, the non-coaxial cable 113 avoids the coaxial cable layout area A1, thereby separating the first coaxial cable 111, the second coaxial cable 112, and the non-coaxial cable 113 to meet the signal transmission requirements of the electronic device.

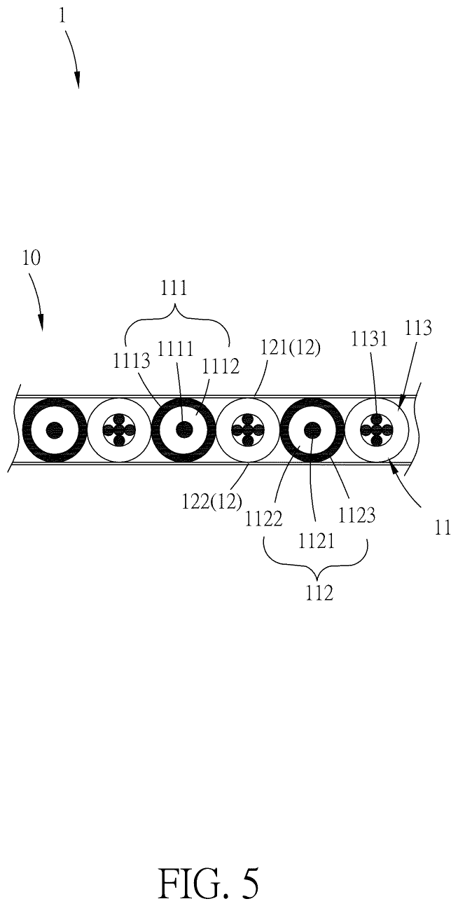

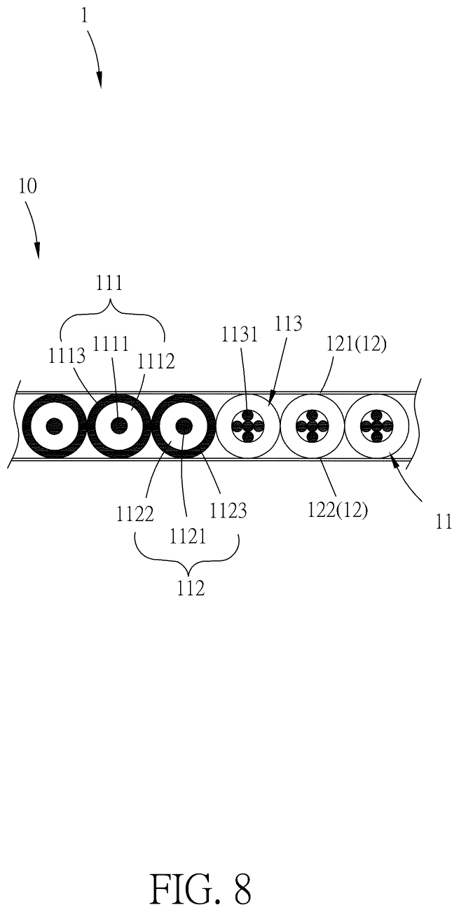

As shown in FIGS. 5 and 8, in the ribbon cable component 10, the adjacent pairs of the first coaxial cable 111, the second coaxial cable 112, and the non-coaxial cable 113 are in close proximity. However, this is not limited to such an arrangement; the adjacent pairs of the first coaxial cable 111, the second coaxial cable 112, and the non-coaxial cable 113 can be spaced apart, as illustrated in the embodiments shown in FIGS. 6 and 9 to 10, the ribbon cable component 10 also includes a cable separating space 101. The cable separating space 101 is used to separate the first coaxial cable 111, the second coaxial cable 112, and the non-coaxial cable 113. It should be noted that the separation distance between the adjacent pairs of the first coaxial cable 111, the second coaxial cable 112, and the non-coaxial cable 113 can be the same or different.

It should be noted that the flexible flat coaxial ribbon cable in the present application may omit certain components, not limited to the embodiments described above.

For example, the flexible flat coaxial ribbon cable in the present application includes: a ribbon cable assembly and a ribbon cable sheath. The ribbon cable assembly comprises a first coaxial cable and a second coaxial cable. The first coaxial cable has a first coaxial cable inner conductor layer, a first coaxial cable inner insulation layer, and a first coaxial cable outer conductor layer, and the first coaxial cable inner insulation layer encases the first coaxial cable inner conductor layer, and the first coaxial cable outer conductor layer encases the first coaxial cable inner insulation layer. The second coaxial cable has a second coaxial cable inner conductor layer, a second coaxial cable inner insulation layer, and a second coaxial cable outer conductor layer, and the second coaxial cable inner insulation layer encases the second coaxial cable inner conductor layer, and the second coaxial cable outer conductor layer encases the second coaxial cable inner insulation layer. The ribbon cable sheath includes an upper gel film and a lower gel film, two sides of the upper gel film and a lower gel film can be joined together, allowing the ribbon cable sheath to become an annular body that can encase and position the ribbon cable assembly, thereby allowing the ribbon cable assembly and the ribbon cable sheath to form a ribbon cable component. In the ribbon cable component, the upper gel film is positioned above the first coaxial cable outer conductor layer and the second coaxial cable outer conductor layer, and the lower gel film is positioned below the first coaxial cable outer conductor layer and the second coaxial cable outer conductor layer, with the upper gel film and lower gel film in contact with the first coaxial cable outer conductor layer and the second coaxial cable outer conductor layer.

In summary, the present application provides a flexible flat coaxial ribbon cable, equipped with a plurality of coaxial cables arranged side by side to reduce the degree of interference and loss during transmitting RF signals or high-speed signals through the coaxial cables, thereby effectively increasing the transmission distance for RF signals or high-speed signals. Additionally, the coaxial cables used in the flexible flat coaxial ribbon cable of this application omits an outer insulation layer, allowing the thickness of the flexible flat coaxial ribbon cable to be effectively reduced for use in spaces with height constraints.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A flexible flat coaxial ribbon cable including:
a ribbon cable assembly, comprising a first coaxial cable and a second coaxial cable, wherein
the first coaxial cable has a first coaxial cable inner conductor layer, a first coaxial cable inner insulation layer, and a first coaxial cable outer conductor layer, and the first coaxial cable inner insulation layer encases the first coaxial cable inner conductor layer, and the first coaxial cable outer conductor layer encases the first coaxial cable inner insulation layer;
the second coaxial cable has a second coaxial cable inner conductor layer, a second coaxial cable inner insulation layer, and a second coaxial cable outer conductor layer, and the second coaxial cable inner insulation layer encases the second coaxial cable inner conductor layer, and the second coaxial cable outer conductor layer encases the second coaxial cable inner insulation layer; and
a ribbon cable sheath, including an upper gel film and a lower gel film, and both sides of the upper gel film and the lower gel film can be joined, and allow the ribbon cable assembly and the ribbon cable sheath to form a ribbon cable component, in the ribbon cable component, the upper gel film is positioned above the first coaxial cable outer conductor layer and the second coaxial cable outer conductor layer, and the lower gel film is positioned below the first coaxial cable outer conductor layer and the second coaxial cable outer conductor layer, and the upper gel film and the lower gel film are in contact with the first coaxial cable outer conductor layer and the second coaxial cable outer conductor layer.

2. The flexible flat coaxial ribbon cable of claim 1, wherein the ribbon cable component has a bending extension segment, and the ribbon cable assembly extends and bends at the bending extension segment.

3. The flexible flat coaxial ribbon cable of claim 1, wherein the ribbon cable assembly further comprises at least a non-coaxial cable, in the ribbon cable component, the upper gel film is positioned above the non-coaxial cable, and the lower gel film is positioned below the non-coaxial cable, wherein the cross-sectional profile shape or size of the first coaxial cable, the second coaxial cable, and the non-coaxial cable can be substantially the same or different; the non-coaxial cable can be a metal cable, an electronic cable, or a plastic cable.

4. The flexible flat coaxial ribbon cable of claim 3, wherein the ribbon cable component further includes a coaxial cable layout area and a non-coaxial cable layout area, and the first coaxial cable and the second coaxial cable are respectively arranged in the coaxial cable layout area, and the non-coaxial cable is arranged in the non-coaxial cable layout area, and the coaxial cable layout area and the non-coaxial cable layout area can overlap or be separate, wherein when the coaxial cable layout area overlaps the non-coaxial cable layout area, the non-coaxial cable is positioned between the first coaxial cable and the second coaxial cable, when the coaxial cable layout area is separated from the non-coaxial cable layout area, the non-coaxial cable is positioned away from the coaxial cable layout area.

5. The flexible flat coaxial ribbon cable of claim 3, wherein the ribbon cable component further includes a cable separating space separating the first coaxial cable, the second coaxial cable, and the non-coaxial cable, and the separation distance between any two adjacent ones of the first coaxial cable, the second coaxial cable, and the non-coaxial cable can be the same or different.

6. The flexible flat coaxial ribbon cable of claim 3, wherein in the ribbon cable component, any two adjacent ones of the first coaxial cable, the second coaxial cable, and the non-coaxial cable are in close contact.

7. The flexible flat coaxial ribbon cable of claim 1, wherein the upper gel film has an upper gel adhesive layer, and the lower gel film has a lower gel adhesive layer, the upper gel adhesive layer adheres to the first coaxial cable outer conductor layer and the second coaxial cable outer conductor layer above the ribbon cable assembly, and the lower gel adhesive layer adheres to the first coaxial cable outer conductor layer and the second coaxial cable outer conductor layer below the ribbon cable assembly.

8. The flexible flat coaxial ribbon cable of claim 1, wherein the upper gel film has an upper conductive layer, and the lower gel film has a lower conductive layer, and the upper conductive layer electrically connects the first coaxial cable outer conductor layer and the second coaxial cable outer conductor layer, and the lower conductive layer electrically connects the first coaxial cable outer conductor layer and the second coaxial cable outer conductor layer.

9. The flexible flat coaxial ribbon cable of claim 1, wherein the upper gel film and the lower gel film are adhesive films, thermoadhesive films, or thermocompression films; and the first coaxial cable outer conductor layer and the second coaxial cable outer conductor layer have single-layer or multi-layer conductor structures made of at least one of braided metal, wrapped metal, or wound metal.

10. The flexible flat coaxial ribbon cable of claim 1 further including a plurality of auxiliary cables, and the auxiliary cables are respectively located on both sides of the ribbon cable assembly to assist in the joining of both sides of the upper gel film and the lower gel film.
